(19) United States
(12) Patent Application Publication
(10) Pub. No.: US 2026/0221480 A1
(43) Pub. Date: Jul. 30, 2026

(54) PROTON EXCHANGE MEMBRANE MATERIAL AND METHODS OF MAKING THE SAME

(71) Applicant: Rensselaer Polytechnic Institute, Troy, NY (US)

(72) Inventors: Chulsung Bae, Cohoes, NY (US); Eun Joo Park, Troy, NY (US); Junyoung Han, Troy, NY (US)

(21) Appl. No.: 18/068,649

(22) Filed: Dec. 20, 2022

Related U.S. Application Data
(63) Continuation of application No. 16/471,358, filed on Dec. 20, 2017, now Pat. No. 11,621,433.
(60) Provisional application No. 62/436,627, filed on Dec. 20, 2016.
(60) Provisional application No. 62/599,045, filed on Dec. 15, 2017.

(51) Int. Cl. H01M 8/1023; C08G 61/02; C08J 5/22; H01M 8/1039

(52) U.S. Cl. CPC H01M 8/1023; C08G 61/02; C08J 5/2262; H01M 8/1039; C08G 2261/126; C08G 2261/1412; C08G 2261/1424; C08G 2261/1452; C08G 2261/146; C08G 2261/148; C08G 2261/312; C08G 2261/3326; C08G 2261/516; C08G 2261/77; C08J 2365/00

(57) ABSTRACT

Hydrocarbon proton exchange membranes are disclosed that are composed of a material including a hydrophobic main chain, and acidic side chains. The main chain includes a polyaryl structure that is substantially free of ether linkages and also includes a fluoromethyl substituted carbon. The acidic side chains include a hydrocarbon tether terminated by a strongly acidic group, such as a fluoroalkyl sulfonate group. Chemical stability of the material is increased by removing the ether linkages from the main chain. The hydrophobic main chain and substantially hydrophilic side chains create a phase-separated morphology that affords enhanced transport of protons and water across the membrane even at low relative humidity levels. These materials are advantageous as membranes for use in fuel cells, redox flow batteries, water hydrolysis systems, sensors, electrochemical hydrogen compressors, actuators, water purifiers, gas separators, etc.

### STATEMENT REGARDING FEDERALLY SPONSORED RESEARCH OR DEVELOPMENT

This invention was made with government support under grant no. DE-EE0007647 awarded by Department of Energy. The government has certain rights in the invention.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Cation or proton exchange membranes facilitate transportation of cations, e.g., H+, Na+, etc., from an anode to a cathode in an electrochemical reaction. Proton exchange membranes are found in myriad of systems and applications, such as the generation of electricity and water in a fuel cell, the splitting of water into hydrogen and oxygen in water hydrolysis, as well as batteries, sensors, hydrogen compressors, and actuators.

In the case of fuel cells and water hydrolysis, protons (H+) are transported through the proton exchange membrane with the help of water molecules. Most hydrocarbon-based proton exchange membranes are prepared from polymers contain aryl-ether linkages, which are not chemically stable in highly acidic conditions. Further, these membranes typically struggle to match the proton conductivity performance of commercial perfluorinated membranes such as Nafion® (E. I. du Pont de Nemours and Company, Wilmington, DE), particularly at low relative humidity levels. However, Nafion®-based membranes are expensive, not designed for use in applications such as fuel cells and water hydrolysis, and disadvantageous for use in certain other applications such as batteries and hydrogen compressors.

### SUMMARY

Some embodiments of the disclosed subject matter are directed to a polymeric material including a polyaryl main chain substantially, free of ether linkages, and including strongly acidic side chains. The main chain is substantially hydrophobic while acidic groups in the acidic side chains are substantially hydrophilic. The hydrophobic and hydrophilic regions on the polymer create a phase-separated morphology that affords enhanced transport of protons and water across the membrane even at low relative humidity levels.

In some embodiments, the main chain of the polymeric material includes a biphenyl group and a CF₃ group. In some embodiments, the acid side chains include a hydrocarbon tether terminated by a strongly acidic group, such as a fluoroalkyl sulfonate group. These materials are advantageous as membranes for use in fuel cells, redox flow batteries, water hydrolysis systems, sensors, electrochemical hydrogen compressors, actuators, water purifiers, gas separators, etc.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic drawing of an electrochemical energy conversion system including a proton exchange membrane according to some embodiments of the present disclosure;

FIG. 2 is a chart of a method for making a proton exchange membrane according to some embodiments of the present disclosure; and

FIG. 3 is a graph comparing the proton conductivity of Nafion® to the materials according to some embodiments of the present disclosure.

### DETAILED DESCRIPTION

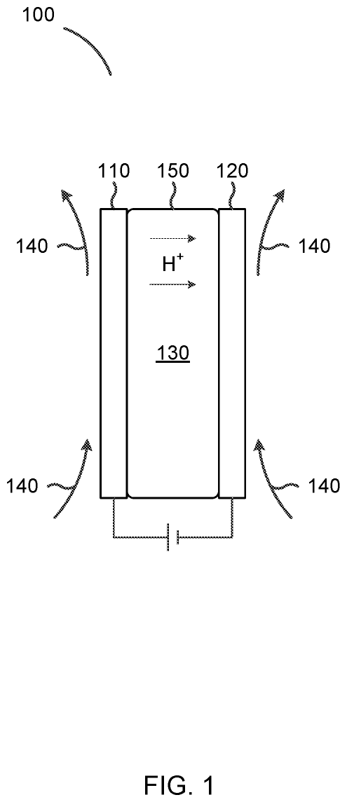

Referring now to FIG. 1, aspects of the disclosed subject matter include an electrochemical energy conversion system 100 including an anode 110, a cathode 120, and an electrolyte 130 disposed between the anode and the cathode. System 100 is suitable for use in numerous applications, such as fuel cells, redox flow batteries, water hydrolysis systems, sensors, electrochemical hydrogen compressors, actuators, water purifiers, gas separators, etc. In some embodiments, anode 110 and cathode 120 are composed of any suitable material for use with electrolyte 130 in system 100. Further, system 100 includes any suitable inlets/outlets 140 to supply reactants to and remove reaction products from anode 110, cathode 120, and electrolyte 130.

In some embodiments, electrolyte 130 is a solid electrolyte. In some embodiments, electrolyte 130 is an ion exchange membrane. In some embodiments, electrolyte 130 is a proton exchange membrane 150. In some embodiments, proton exchange membrane 150 is composed of a material which has a substantially ether-free polyaryl main chain and acidic side chains. In some embodiments, the polyaryl main chain is substantially hydrophobic while the side chain is substantially hydrophilic. In some embodiments, the material is a block copolymer. In some embodiments, the material includes a polymer according to the following formula I:

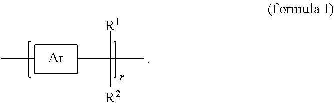

In some embodiments, Ar includes at least one aryl group, R¹ includes a haloalkyl group, R² includes an acidic chain, and r is greater than at least about 100. In some embodiments, r is greater than at least about 1000. In some embodiments, r is greater than at least about 10000. In some embodiments, r is greater than at least about 100000. As used herein, the term “halo” is used to indicate the inclusion of a halogen, e.g., fluorine. Further, as used herein, the term “alkyl” is used to indicate a hydrocarbon structure.

In some embodiments, the at least one aryl group Ar includes no ether group. In some embodiments, there is no ether group adjacent the at least one aryl group Ar. The absence of these ether groups increases the chemical stability of the material in highly acidic conditions. In some embodiments, the at least one aryl group Ar is a polyphenyl group, e.g., biphenyl, triphenyl, terphenyl, etc. In some embodiments, the at least one aryl group Ar further includes a hydrocarbon chain. The hydrocarbon chain can be linear or branched, substituted or unsubstituted. In some embodiments, the at least one aryl group Ar includes:

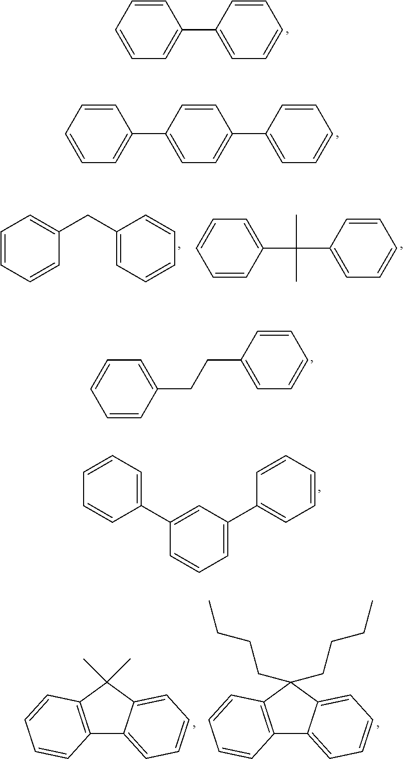

or combinations thereof.

As discussed above, the polyaryl main chain is substantially hydrophobic. In some embodiments, the at least one aryl group Ar is substantially hydrophobic. In some embodiments, the haloalkyl group R¹ is also a substantially hydrophobic group. In some embodiments, the haloalkyl group R¹ is a haloalkane. In some embodiments, R¹ includes CF₃. Further embodiments and examples of the polymeric main chain, as well as methods of making of the same, can be found in International Application No. PCT/US2015/061036, published as WO/2016/081432, which is incorporated herein by reference in its entirety.

In some exemplary embodiments, the material includes a polymer according to the following structure of formula 1A:

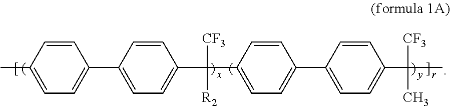

In some embodiments, r is greater than at least about 100. In some embodiments, r is greater than at least about 1000. In some embodiments, r is greater than at least about 10000. In some embodiments, r is greater than at least about 100000. As can be seen in formula 1A, in this exemplary embodiment, Ar from formula I is a biphenyl group

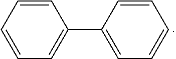 [SMILES: c1ccc(-c2ccccc2)cc1]

In some embodiments of formula 1A, x+y=1. In some embodiments, x=1 and y=0. In some embodiments, x is about 0.4 to about 0.7, while y is about 0.3 to about 0.6, including all the integers there between. In some embodiments, x is about 0.65, while y is about 0.35. In some embodiments, x is about 0.44, while y is about 0.56.

In some embodiments, acidic side chain R² includes a hydrocarbon tether connecting the main chain with an acidic group. In some embodiments, acidic side chain R² includes the following structure of formula II:

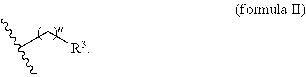

In some embodiments, R³ includes at least one acidic group, and n is from 1 to about 20. In some embodiments, other than the presence of R³, the hydrocarbon tether is unsubstituted. In some embodiments, in addition to R³, the hydrocarbon tether includes at least one substitution.

In some embodiments, R³ is strongly electron withdrawing. In some embodiments, R³ includes at least one haloalkyl sulfonate group, halophenyl sulfonate group, alkyl sulfonate group, sulfonate group, alkyl phosphonate group, alkyl carboxylate group, a substituted hydrocarbon including at least one haloalkyl sulfonate group, halophenyl sulfonate group, alkyl sulfonate group, sulfonate group, alkyl phosphonate group, alkyl carboxylate group, or combinations thereof. In some embodiments, R³ includes at least one fluoroalkyl sulfonate group and/or a substituted hydrocarbon including at least one fluoroalkyl sulfonate group. In some embodiments, R³ includes CF₂CF₂OCF₂CF₂SO₃H. In some embodiments, R³ includes the following structure of formula III:

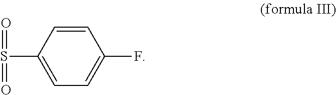

In some exemplary embodiments, the material includes a polymer according to the following structure of formula IV:

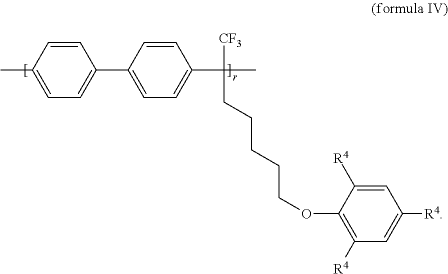

In some embodiments, r is greater than at least about 100. In some embodiments, r is greater than at least about 1000. In some embodiments, r is greater than at least about 10000. In some embodiments, r is greater than at least about 100000. As can be seen in formula IV, in this exemplary embodiment, Ar from formula I is a biphenyl group

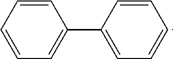 [SMILES: c1ccc(-c2ccccc2)cc1]

In some embodiments, at least one R⁴ includes an acidic group. In some embodiments, R⁴ is selected from hydrogen, a haloalkyl sulfonate group, a halophenyl sulfonate group, an alkyl sulfonate group, a sulfonate group, an alkyl phosphonate group, an alkyl carboxylate group, or a substituted hydrocarbon including at least one haloalkyl sulfonate group, halophenyl sulfonate group, alkyl sulfonate group, sulfonate group, alkyl phosphonate group, or alkyl carboxylate group, or combinations thereof. In some embodiments, at least one R⁴ includes a fluoroalkyl sulfonate group or a fluorophenyl sulfonate group. In some embodiments, at least one R⁴ includes CF₂CF₂OCF₂CF₂SO₃H. In some embodiments, at least one R⁴ includes the structure of formula III above.

In some embodiments, proton exchange membrane 150 is composed substantially entirely of material consistent with the embodiments described above. In some embodiments, the material is incorporated into or attached to a base polymeric structure, such as a commercially available membrane.

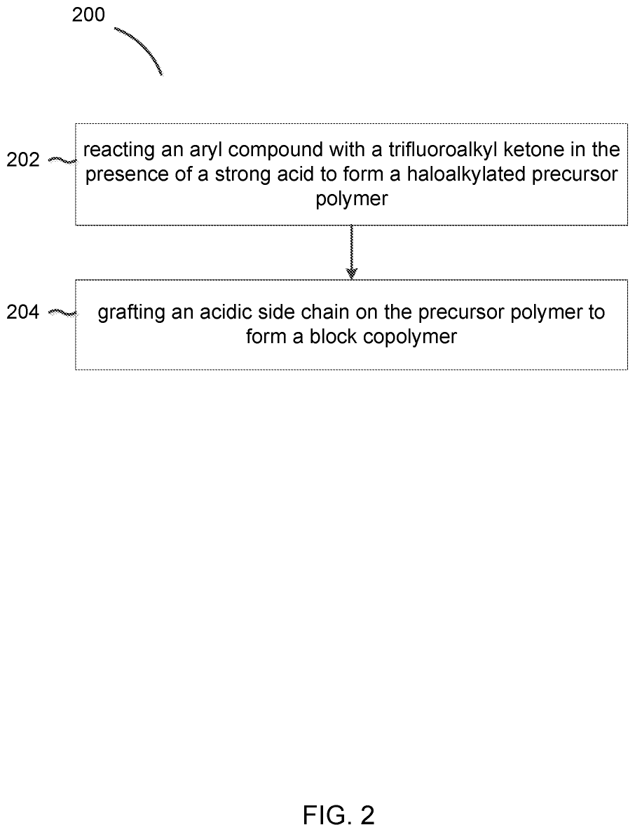

Referring now to FIG. 2, some aspects of the disclosed subject matter include a method 200 of making a proton exchange membrane material. In some embodiments, at 202, an aryl compound is reacted with a trifluoroalkyl ketone in the presence of a strong acid to form a haloalkylated precursor polymer. At 204, an acidic side chain is grafted on the precursor polymer. In some embodiments, the acidic side chain is grafted from and/or to the precursor polymer. The reaction materials suitable for use in method 200 are those resulting in a material with a structure consistent with those shown in formulas I-IV above.

In some embodiments, the polymer includes the following structure:

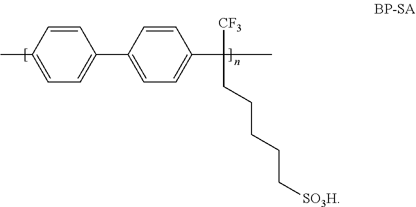

In other embodiments, the polymer includes the following structure:

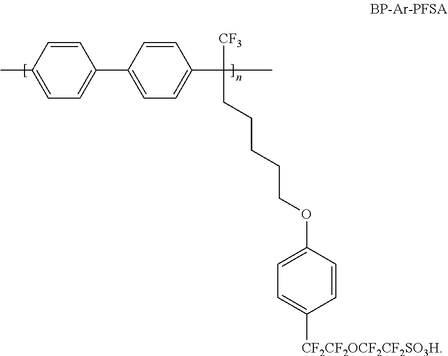

For BP-SA and BP-Ar-PFSA, the polymer includes acidic sulfonate groups connected to the aromatic polymer backbone via a flexible tether, e.g., a linear alkyl chain for BP-SA and a fluoroalkyl chain for BP-Ar-PFSA.

In yet other embodiments, the polymer includes the following structure:

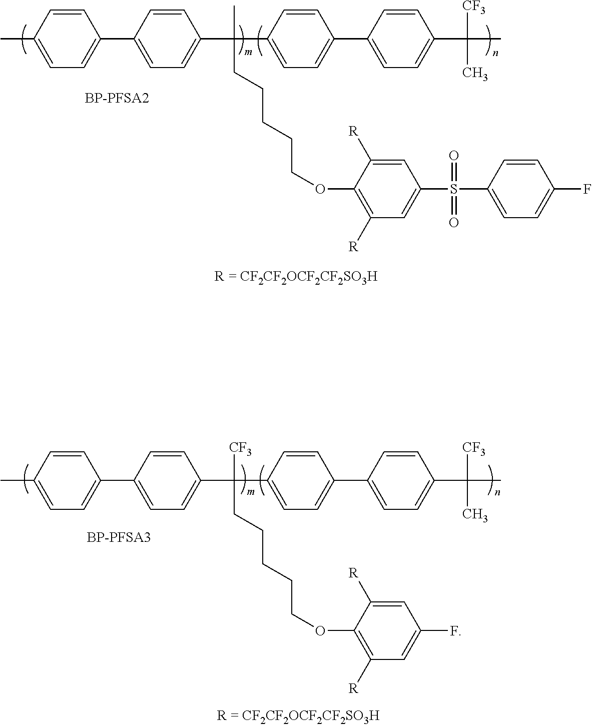

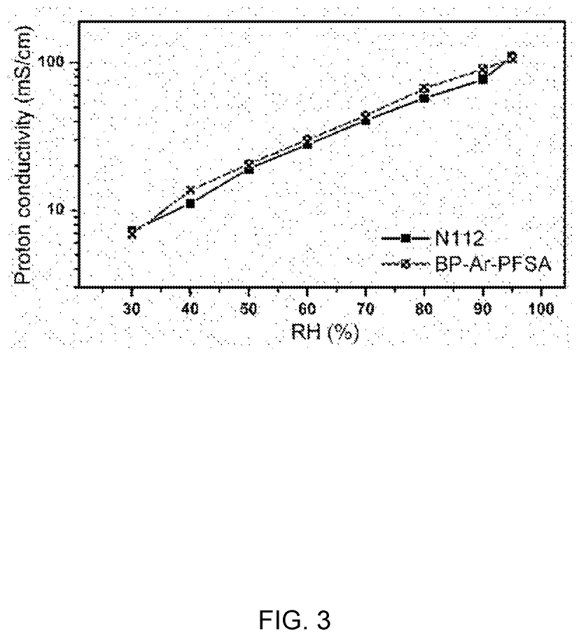

The polymeric materials consistent with the embodiments of the present disclosure are advantageous for use as membrane materials, particularly in high temperature, low relative humidity applications. The ether-free polyaryl backbone of the polymeric main chain provides increased chemical stability under acidic conditions. Additionally, the materials of the present disclosure benefit from the presence of heavy fluorine-including side chains that reduce swelling. As a result, membranes including the material according to the present disclosure maintain mechanical stability. Further, the performance of these materials compares favorably to perfluorosulfonic acid polymers such as Nafion®. Referring to FIG. 3, the materials of the present disclosure exhibit similar proton conductivity to Nafion® due to the relatively strong acidity of the acidic side chains produced from the acidic groups. Further the combined effects of the hydrophobic main chain, the hydrophilic, acidic side chain, and hydrocarbon tether separating them advantageously create a nano-scale phase separated morphology like that of Nafion® that enhances transport of protons and water. However, while materials such as Nafion® are expensive to produce and modify, the substantially hydrocarbon structure of the materials according to the present disclosure are manufactured at a much lower cost and are easier to modify and tune for specific applications.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

1. A proton exchange membrane material comprising a polymer according to formula IV: 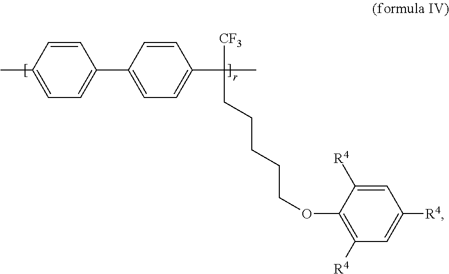
wherein each R⁴ includes hydrogen, a haloalkyl sulfonate group, a halophenyl sulfonate group, an alkyl sulfonate group, a sulfonate group, an alkyl phosphonate group, an alkyl carboxylate group, or a substituted hydrocarbon including at least one haloalkyl sulfonate group, halophenyl sulfonate group, alkyl sulfonate group, sulfonate group, alkyl phosphonate group, or alkyl carboxylate group;
at least one R⁴ includes at least one acidic group; and
r is greater than at least about 100.

2. The material of claim 1, wherein at least one R⁴ includes a haloalkyl sulfonate group.

3. The material of claim 2, wherein the haloalkyl sulfonate group is a fluoroalkyl sulfonate group.

4. The material of claim 1, wherein at least one R⁴ includes a halophenyl sulfonate group.

5. The material of claim 4, wherein the halophenyl sulfonate group is a fluorophenyl sulfonate group.

6. The material of claim 1, wherein the acidic group is an optionally substituted sulfonate.

7. The material of claim 6, wherein the R⁴ includes CF₂CF₂OCF₂CF₂SO₃H.

8. The material of claim 1, wherein the acidic group is an optionally substituted phosphonate.

9. The material of claim 8, wherein the acidic group is an alkyl phosphonate.

10. The material of claim 1, wherein the acidic group is an optionally substituted carboxylate.

11. The material of claim 10, wherein the acidic group is an alkyl carboxylate.

12. The material of claim 1, wherein the acidic group is included in a haloalkyl sulfonate group, a halophenyl sulfonate group, an alkyl sulfonate group, an unsubstituted sulfonate group, an alkyl phosphonate group, an alkyl carboxylate group, or in a substituted hydrocarbon including at least one haloalkyl sulfonate group, halophenyl sulfonate group, alkyl sulfonate group, sulfonate group, alkyl phosphonate group, or alkyl carboxylate group.

13. An electrochemical energy conversion system comprising:
an anode;
a cathode; and
a proton exchange membrane disposed between the anode and the cathode,
wherein the proton exchange membrane includes a polymer including the structure according to formula IV: 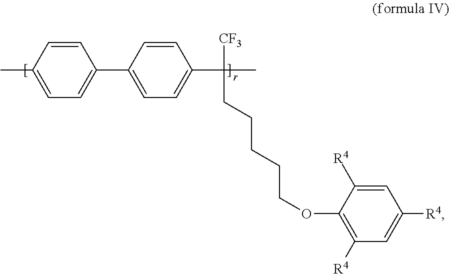
wherein each R⁴ includes hydrogen, a haloalkyl sulfonate group, a halophenyl sulfonate group, an alkyl sulfonate group, a sulfonate group, an alkyl phosphonate group, an alkyl carboxylate group, or a substituted hydrocarbon including at least one haloalkyl sulfonate group, halophenyl sulfonate group, alkyl sulfonate group, sulfonate group, alkyl phosphonate group, or alkyl carboxylate group;
at least one R⁴ includes at least one acidic group; and
r is greater than at least about 100.

14. The system of claim 13, wherein at least one R⁴ is the acidic group that includes a fluoroalkyl sulfonate group or a fluorophenyl sulfonate group.

15. The system of claim 13, wherein the acidic group is a an optionally substituted sulfonate.

16. The system of claim 15, wherein the R⁴ includes CF₂CF₂OCF₂CF₂SO₃H.

17. The system of claim 13, wherein the acidic group is an optionally substituted phosphonate.

18. The system of claim 13, wherein the acidic group is an optionally substituted carboxylate.

19. The system of claim 18, wherein the acidic group is an alkyl carboxylate.

20. The system of claim 13, wherein the acidic group is included in a haloalkyl sulfonate group, a halophenyl sulfonate group, an alkyl sulfonate group, an unsubstituted sulfonate group, an alkyl phosphonate group, an alkyl carboxylate group, or in a substituted hydrocarbon including at least one haloalkyl sulfonate group, halophenyl sulfonate group, alkyl sulfonate group, sulfonate group, alkyl phosphonate group, or alkyl carboxylate group.
